(19) United States
(12) Patent Application Publication
(10) Pub. No.: US 2010/0057520 A1
(43) Pub. Date: Mar. 4, 2010

(54) SYSTEM AND METHOD FOR STANDARDIZING AND MANAGING INFORMATION TECHNOLOGY PRODUCTS

(75) Inventor: Barry Rejai, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/203,675

(22) Filed: Sep. 3, 2008

(51) Int. Cl. G06Q 10/00

(52) U.S. Cl. 705/9; 705/8

(57) ABSTRACT

A process for managing information technology (IT) products within an organization may include defining categories of IT products being utilized by an organization. A management structure may be assigned to each IT product category, where the management structure identifies at least one individual having responsibility for each respective IT product category. An inventory list of IT products being used by the organization may be created. The IT products may be mapped to the IT product categories and management structure. A disposition status from among a plurality of potential disposition statuses may be assigned to each of the IT products.

### BACKGROUND

Information technology generally means computer technology and information stored on computers. For the past several decades, information technology has matured as computer technology has evolved from mainframe computers to the age of distributed computers and the Internet. During the evolution of computer technology, corporations were in the position of providing computer services to its employees.

Large corporations developed and purchased many different computer technologies to support the many different facets of the corporation. Over the years, large corporations have amassed a significant amount of information technology. In today's world of information technology, complexity has become the root cause of many problems and issues in the areas of stability, manageability, and operation/infrastructure costs. Complex IT environments are inherently expensive to operate, more difficult to manage, and can be unpredictable every time changes are introduced.

Many IT organizations are victims of the past and have operated via an individualism approach (i.e., my application, my servers, my functionality, etc.), which has led to a silo mentality, and niche piecemeal capabilities being provided by hundreds of software and hardware technologies. Companies have made past technology choices within silo organizations (inside and outside of IT groups) that resulted in vertical, redundant, and overkill solutions in nature. Simply stated, many companies today cannot afford the breadth of its technology portfolio because IT spend by business function is greater than their industry peers and due to budgetary constraints.

### SUMMARY

To overcome the problem of companies having an overabundance of IT to manage and support, the principles of the present invention provide for a practical process for rationalization and standardization of technology. To standardize technology, a taxonomy or categorization of the technology is performed to define domains, sub-domains, and definitions for each technology. Dispositions of redundant and underutilized IT technology may thereafter be performed to ultimately reduce costs for organizations.

One embodiment of a process for managing information technology (IT) products within an organization may include defining categories of information technology products being utilized by an organization. A management structure may be assigned to each IT product category, where the management structure identifies at least one individual having responsibility for each respective IT product category. An inventory list of IT products being used by the organization may be created. The IT products may be mapped to the IT product categories and management structure. A disposition status from among a plurality of potential disposition statuses may be assigned to each of the IT products.

### BRIEF DESCRIPTION OF THE DRAWINGS

Illustrative embodiments of the present invention are described in detail below with reference to the attached drawing figures, which are incorporated by reference herein and wherein:

FIG. 1 is a flow diagram of an illustrative process for defining a taxonomy of information technology utilized by an organization;

FIG. 2 is a flow diagram of an illustrative process for assigning domain ownership to each domain and sub-domain of a taxonomy of information technology;

FIG. 3 is a flow diagram of an illustrative process for identifying information technology being utilized by an organization;

FIG. 4 is a flowchart of an illustrative disposition process for information technology products; and

FIG. 5 is a flow diagram of an illustrative process for standardizing information technology in accordance with the principles of the present invention.

### DETAILED DESCRIPTION OF THE DRAWINGS

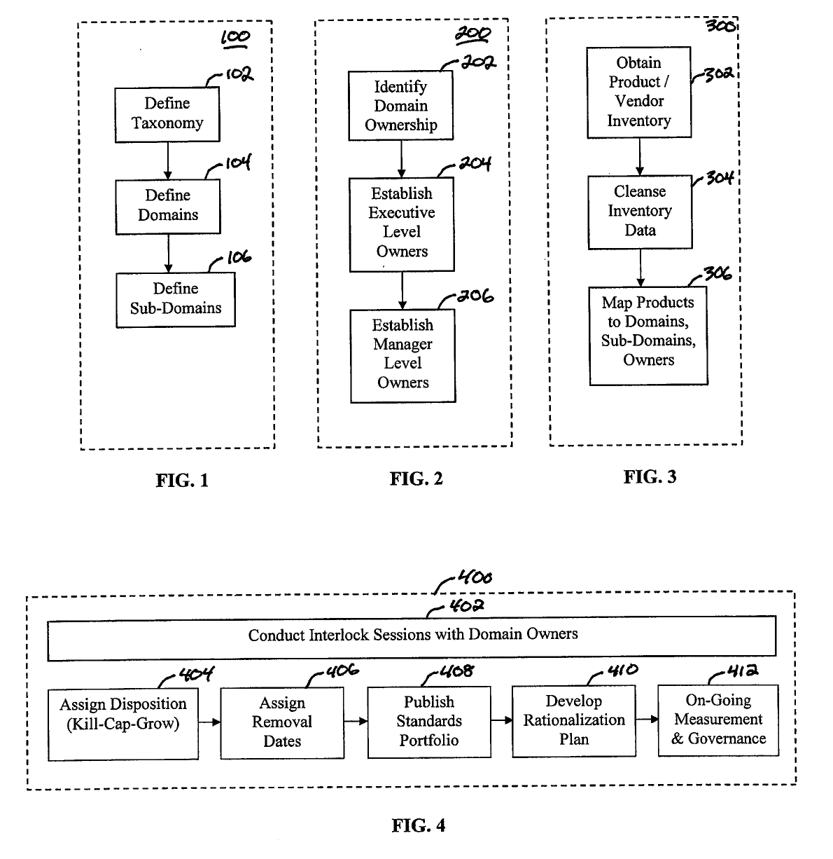

FIG. 1 is a flow diagram of an illustrative process 100 defining a taxonomy of information technology utilized by an organization at step 102. Taxonomy means the science of classification; for the purposes of this description, taxonomy means a category system that can be used to classify and organize products and vendors. In categorizing the information technology, the information technology may be categorized by products and vendors, where the term “product” refers to hardware and software products (e.g., Adobe Acrobat®). The products and vendors may further be classified hierarchically into two levels, by domain at step 104 and sub-domain at step 106. The taxonomy definitions of the technology are used to assist the organization in understanding the full scope of information technology that is currently being utilized.

TABLE I provides an illustrative taxonomy or classification breakdown of information technology utilized by an organization. The domains and sub-domains are representative of ones utilized by a telecommunication service provider. It should be understood that categories are illustrative and alternative domains and sub-domains are possible, especially for organizations in other business sectors.

TABLE I

| Domain | Sub-Domain | Definition |
|---|---|---|
| App Dev Tools | App Dev Tools | Encompasses all tools to construct and deploy business applications |
| | Testing Tools | |
| BI | — | Tools needed to integrate and deliver information supporting business |
| | | decision making |
| Computing | Data Center | Applies to servers, storage, and archive devices with their respective |
| | Mainframe Hosting | operating systems, interfaces, and drivers that provide the execution |
| | MidRange Hosting | foundation on a framework for interoperability, scalability, and |
| | Storage Management | portability |
| Data Services | Directory Services | Provide capabilities to enable multiple separate communication |
| & Network | Email/Messaging | networks to be connected together for delivery of data |
| | WAN/LAN/Remote Access | |
| Database | Distributed Databases | Focuses on managing the technologies and integrity of the information |
| | Mainframe Databases | assets of the company |
| Desktop | Personal Computing Platform | Supplies the end user hardware, software, services, and management |
| | Personal Computing Software | capabilities to support the internal client computing environment or |
| | | personal computing |
| EAI | Application Web Hosting | Provides functions needed to integrate heterogeneous applications into |
| | Integration | seamless business processes as well as delivering high-volume |
| | | transactions |
| Enterprise | External Portals | A single web-based point of access for delivery of applications, |
| Information | Internal Portals | services, and content to employees, customers, and suppliers |
| Portals | | |
| Information | — | Addresses data standards, data quality, data formats and models |
| IT Service | Service Delivery | Addresses principles that enable IT services to be provided effectively |
| Management | Service Support | as well as the management and delivery of those services |
| Knowledge | — | Responsible for managing the tacit and explicit knowledge contained |
| Management | | with the enterprise |
| Security | Detection & Response | Addresses all of the infrastructure elements in order to provide true |
| | Prevention | protection of information assets |
| Voice Services & | Call Center Technology, ACD, | Includes technologies that facilitate voice communications between |
| Call Center | IVR | employees, customers and suppliers plus enables day-to-day operations |
| | Voice Systems/PBX/Voicemail | of call centers |

FIG. 2 is a flow diagram of an illustrative process 200 for assigning domain ownership to each domain and sub-domain. Assigning ownership within an organization provides leadership and responsibilities so people within the organization may be held accountable for tasks set forth to reduce information technology categorized by the taxonomy process 100 of FIG. 1. In one embodiment, three levels of ownership to form a management structure may be assigned, including executive, director, and manager. The executive ownership level may be a vice president within the organization, director level may be a senior manager within the organization, and manager level may be a mid-tier or supervisor within the organization. In one embodiment, only one individual is assigned an ownership position at each sub-domain level. Because of the complex nature of information technology, each of the ownership positions are to be IT professionals, although such assignments are not mandatory.

The owners of the domains and sub-domains are ultimately responsible for budgeting and disposition of information technology products, as further described herein. TABLE II is an illustrative list of classifications of information technology products and ownership assignments for each classification.

TABLE II

| | | Domain | Domain | Domain |
|---|---|---|---|---|
| | | Owner | Owner | Owner |
| Domain | Sub-Domain | (Exec) | (Dir) | (Mgr) |
| App Dev | App Dev Tools | Bingham | Carver | Pratt |
| Tools | Testing Tools | | | |
| BI | — | Bingham | Bingham | Gibson |
| Computing | Data Center | Lark | Hanson | Benson |
| | Mainframe Hosting | | Halthaus | Wesley |
| | MidRange Hosting | | Halthaus | Allen |
| | Storage Management | | Brown | Brown |
| . . . | . . . | . . . | . . . | . . . |
| Voice | Call Center | Lark | Hadley | Newsom |
| Services & | Technology, | | | |
| Call Center | ACD, IVR | | | |
| | Voice Systems | | | |

FIG. 3 is a flow diagram of an illustrative process 300 for identifying information technology products being utilized by an organization. The process 300 starts at step 302, where an inventory of the information technology products identified by a product and vendor is created. The inventory is initially a baseline inventory that shows each information technology product that is being supported by the IT department. The number of instances of each product is generally not important, but the total number of product licenses, users, or other indicator of organization utilization may be listed for later assessment when determining disposition of the IT products. TABLE III is an illustrative “raw” list of IT products as further identified as being hardware or software (H or S).

TABLE III

| | | | | Technology |
|---|---|---|---|---|
| H or | | | Product | Capability |
| S | Vendor | Product | Versions | Comments |
| S | AccessData | Ultimate Toolkit | — | — |
| S | Adobe | Acrobat Standard Ed. | — | — |
| S | Adobe | Acrobat Professional Ed. | 6.5 | — |
| S | Adobe | Acrobat Professional Ed. | 7.0 | — |
| . . . | . . . | . . . | . . . | . . . |
| S | Mercury | Test Director | 8.0 | — |
| | Interactive/ | | | |
| | HP | | | |

At step 304, the baseline inventory may be cleansed. In cleansing the baseline inventory, duplicates of each IT product are eliminated, multiple versions of the same product may be eliminated, and similar vendor and product names are eliminated. Essentially, the cleansing step 304 is used to normalize the raw data of the baseline inventory to make the next step 306 of mapping the IT products to the domains, sub-domains, and owners more efficient. TABLE IV is an illustrative cleansed list of IT products derived from the raw list of TABLE III.

TABLE IV

| | | | | Technology |
|---|---|---|---|---|
| H or | | | Product | Capability |
| S | Vendor | Product | Versions | Comments |
| S | AccessData | Ultimate Toolkit | — | — |
| S | Adobe | Acrobat Standard Ed. | — | — |
| S | Adobe | Acrobat Professional Ed. | 7.0 | — |
| . . . | . . . | . . . | . . . | . . . |
| S | Mercury | Test Director | 8.0 | — |
| | Interactive/ | | | |
| | HP | | | |

In the mapping step 306, each IT product is assigned a domain, sub-domain, and owners according to the previously defined taxonomy of the IT products provided by process 100 of FIG. 1. As a result of the mapping, rationalization of whether to continue utilizing the IT product may be performed by the owners of the associated domain, and, for those IT products to be kept, a standardization plan may be created. Rationalization of whether to continue utilizing the IT product may be performed by any decision process by the owners of the domain in which the IT product is associated. TABLE V is an illustrative mapped list of IT products to domains and owners.

TABLE V

| | | | | | | Domain | Domain | Domain | Technology |
|---|---|---|---|---|---|---|---|---|---|
| H | | | Product | | Sub- | Owner | Owner | Owner | Capability |
| or S | Vendor | Product | Versions | Domain | Domain | (Exec) | (Dir) | (Mgr) | Comments |
| S | Adobe | Adobe | — | Desktop | Personal | Lark | Norton | Sole | — |
| | | Acrobat | | | Computing | | | | |
| | | Professional | | | Software | | | | |
| S | Adobe | Breeze | — | Desktop | Personal | Lark | Norton | Sole | — |
| | | Publishing | | | Computing | | | | |
| | | | | | Software | | | | |
| S | BMC | BMC | — | IT Service | Service | Bingham | Carver | Pratt | — |
| | Software, | Impact | | Management | Support | | | | |
| | Inc. | Explorer | | | | | | | |
| . . . | . . . | . . . | . . . | . . . | . . . | . . . | . . . | . . . | . . . |
| S | Cisco | Campus | 4.0 | Data | WAN/LAN/ | Lark | Courtney | Holhaus | — |
| | | Manager | | Services & | Remote | | | | |
| | | | | Network | Access | | | | |

FIG. 4 is a flowchart of an illustrative disposition process 400 on the cleansed list (TABLE IV) or mapped list (TABLE V) of IT products. The disposition process 400 is used to minimize the IT products utilized by an organization. At step 402, one or more interlock sessions may be performed. The interlock sessions are meetings between owners of the domains to rationalize which IT products to kill, cap, or grow by “negotiating” or otherwise determining what disposition category to assign the IT products. The interlock session(s) may enable owners of domains to analyze products and vendors to identify different IT products with the same or similar functionality. Resulting from the analysis, clusters of IT products that perform the same or similar functions are determined. The clusters of IT products enable the owners of the domains to rationalize consolidation and standardization of the IT products, which ultimately leads to a significant cost savings for the organization.

At step 404, disposition assignment of the IT products existing within the IT organization is performed. This assignment process is one of the more difficult steps for owners of the domains due to paradigm shifts, change, and any number of other emotional issues for the ownership while making disposition decisions. It is recommended that three categories of disposition be followed, including “kill,” “cap,” and “grow.” An IT product assigned “kill” is a technology that will be removed or retired from the organization through a life cycle event. The “cap” assignment is made to a technology that cannot be killed for reasons of major dependencies or until a target state technology has been defined; the IT product is to be maintained as-is. A “grow” assignment is made to a technology that will be made an organization standard and the IT organization will invest in supporting the technology (these technologies are generally horizontal technologies or anchor solutions). The caveat is that investments in technologies marked as “kill” or “cap” may continue, but only when the payback for that investment is realized prior to its targeted retirement date. Also, decisions on “kill-cap-grow” are to be kept open based on business and technology changes so that the organization does not end up back in the same state of having too much technology products to support.

Two additional disposition categories may be utilized, including “research,” which means that the domain owner needs extra time to determine the disposition of one of “kill,” “cap,” and “grow,” and “retired,” which means the product has actually been removed from the IT environment. As part of the review process, explanation relative to the disposition decision is provided as well as a tracking mechanism (e.g., add or change) in case dispositions are changed in the future. It should be understood that the terms “kill,” “cap,” “grow,” “research,” and “retired” are illustrative and that alternative terms may be utilized to indicate the same or analogous functionality.

For each of the “kill” technologies, a removal date is assigned at step 406 that refers to the actual date that the domain owner commits to removing or discontinuing use of the IT product. TABLE VI is an illustrative list showing disposition assignments to each IT product.

TABLE VI

| | | | | | | | Add/ | | Remove |
|---|---|---|---|---|---|---|---|---|---|
| H | | | Product | | | | Change | Explanation | (de-install) |
| or S | Vendor | Product | Versions | Domain | . . . | Disposition | (Month) | of Decision | by |
| S | Adobe | Adobe | — | Desktop | . . . | Grow | — | Stable and used | — |
| | | Acrobat | | | | | | by many | |
| | | Pro | | | | | | groups | |
| S | Adobe | Breeze | — | Desktop | . . . | Kill | August 2008 | Other products | Dec. 31, 2009 |
| | | Publishing | | | | | | with same | |
| | | | | | | | | functions | |
| S | BMC | BMC | — | IT Service | . . . | Grow | — | Useful and | — |
| | Software, | Impact | | Management | | | | supported | |
| | Inc. | Explorer | | | | | | | |
| . . . | . . . | . . . | . . . | . . . | . . . | . . . | . . . | . . . | . . . |
| S | Cisco | Campus | 4.0 | Data | . . . | Cap | June 2008 | Stable but | — |
| | | Manager | | Services & | | | | cannot remove | |
| | | | | Network | | | | | |

At step 408, a standards portfolio is published so that each of the IT products that have been tagged as “grow” are to be published in a single list for the IT organization to treat as IT products that are to be supported going forward. Users of the published standards portfolio may include IT architects, software engineers, vendor contract analysts, etc. TABLE VII shows an illustrative list of standard IT products that have been determined through the disposition process to be supported in the future by the organization.

TABLE VII
Disposition Grow

| | | | | Technology |
|---|---|---|---|---|
| | | | | Capability |
| Domain | Sub-Domain | Vendor | Product | Comments |
| Desktop | Personal | Adobe | Adobe Acrobat | — |
| | Computing | | Professional | |
| | Software | | | |
| IT Service | Service | BMC | BMC Impact | — |
| Management | Support | Software, | Explorer | |
| | | Inc. | | |
| . . . | . . . | . . . | . . . | . . . |

At step 410, a rationalization plan may be developed, where the rationalization plan may simply be a plan for each of the domain owners to show how each will remove all IT technologies designated as “kill.” The plans may range from days, to weeks, to years. The plan is complete or successful upon 100 percent of technology removal or discontinued use and transitioned into IT products that are defined as “grow” IT products. During the interlock sessions of step 402, it is suggested that certain logistics be communicated to each of the domain owners. For example, sharing of rationalization high-level plans across domains, not questioning the validity of why certain technology is being eliminated, limited time to accomplish the walkthrough for each domain, and so forth. TABLES VIIIa and VIIIb are illustrative table showing a rationalization plan for removing IT products assigned as “kill.”

TABLE VIIIa

| | | | | | | Planned | Planned | Planned | Planned | |
|---|---|---|---|---|---|---|---|---|---|---|
| Product | | Total Cost | Domain | Domain | Domain | Removal | Removal | Removal | Removal | |
| to be | Vendor | of | Owner | Owner | Owner | Quarter | Year | Quarter | Year | |
| Removed | Name | Ownership | (Exec) | (Dir) | (Mgr) | Start | Start | Complete | Complete | . . . |
| . . . | . . . | . . . | . . . | . . . | . . . | . . . | . . . | . . . | . . . | |

TABLE VIIIb

| | Business | | | | | |
|---|---|---|---|---|---|---|
| Estimated | Applications | Potential | Project | How will this | | Notes from |
| Cost of | using this | Risks and/or | ID/Name (if | asset be | Confidence | Interlock |
| Removal | Technology | Dependancies | available) | removed? | Level | Sessions |
| . . . | . . . | . . . | . . . | . . . | . . . | . . . |

At step 412, on-going measurement and governance may be performed by using metrics for measuring technology reduction targets versus planned reduction targets of the IT products assigned as “kill”. It is suggested that a target be set at the executive level (e.g., 20 percent reduction of IT technologies year over year). In addition, it is suggested for a central IT organization to govern adherence to the set technology standards as well the execution of rationalization plans. TABLE IX is an illustrative table showing a count of disposition, where the count is used to show how many IT products have been discontinued as compared to the total number of IT products that have been assigned “kill.”

TABLE IX
Disposition Count

| Domain | Domain | Domain | | | | | | |
|---|---|---|---|---|---|---|---|---|
| Owner | Owner | Owner | | | | | | |
| (Exec) | (Dir) | (Mgr) | Cap | Grow | Kill | Research | Retired | Grand Total |
| Bingham | Bingham | Gibson | 13 | 3 | 12 | 2 | 5 | 35 |
| Clymer | Culver | Rueger | 8 | 9 | 14 | 1 | 9 | 41 |
| Lark | Courtney | Brown | 26 | 16 | 31 | 3 | 27 | 103 |

TABLE X is a list of exemplary IT products that define IT product standards within an organization after the above-described rationalization and standardization process. As shown the list may include a “standards domain” column that lists IT product categories and “enterprise” IT products” and “desktop” IT products that are classified within each of the standards domains. The standards may be distributed throughout the organization so that each member responsible for purchasing IT products can ensure that IT product purchases meet the IT product standards of the organization.

TABLE X

| STANDARDS | | |
|---|---|---|
| DOMAIN | ENTERPRISE | DESKTOP |
| Operating System | Sun Solaris 10 | Windows XP SP2 |
| | Windows 2003 STD R2 SP2 | |
| Virtualization | VMWare ESX 3.0.2 | VMWare Workstation 6.x |
| | Sun Containers/Zones 10 | MS Virtual PC |
| | VMWare Virtual Center 2.0.2 | |
| Security | SiteMinder WAM 5.5 SP3 | McAfee Virus Scan |
| | | Enterprise 8.5i |
| Database Server | Oracle 10g | Microsoft Access |
| | Microsoft SQL Server 2005 SP2 | 2007 |
| Application Server | WebLogic Platform 10.0 | N/A |
| | Weblogic 9.2 mp2 | |
| Web Server | Sun Java System Web Server 6.1 | N/A |
| | (aka iPlanet Sun One) | |
| | Apache HTTP Web Server | |
| | Microsoft IIS 2003 R2 STD SP2 | |
| Integration (EAI) | BEA AquaLogic ALSB 2.5 (aka ESB) | N/A |
| Language | Java Enterprise Edition (JDK/JRE) | N/A |
| | Visual Studio .NET | |
| Information | Harte-Hanks Trillium | N/A |
| Business | Informatica PowerCenter 8 AE | N/A |
| Intelligence | Oracle OBI EE | |
| Client | N/A | Web-Enabled |
| | | Client IE 6 |

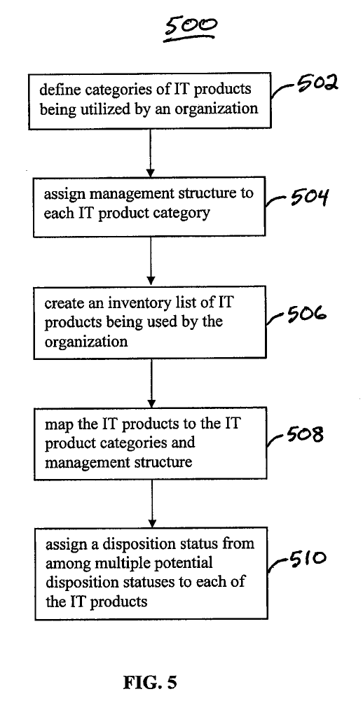

FIG. 5 is a flow diagram of an illustrative process 500 for performing information technology reduction in accordance with the principles of the present invention. The process 500 starts at step 502, where categories of information technologies being utilized by an organization are defined. The IT categories may be generally described as domains and more narrowly described as sub-domains. At step 504, a management structure is assigned to each IT category. The management structure is hierarchical in that there is a hierarchy of individuals that ate assigned to each IT category, thereby providing for a chain-of-command to ensure that each individual associated with the IT category has a responsibility to ensure that tasks within the IT category are performed.

At step 506, an IT inventory list of IT products being used by the organization is created. The IT inventory list is a raw list of IT products that include each IT product, both hardware and software, being used by the organization. Depending on the size of the organization and duration that the organization has been in operation, the IT inventory list may include thousands of IT products. To minimize the raw data list, the IT inventory list may be cleansed to eliminate duplicates and redundancies, including removing multiple versions of the same IT product if the different versions are backward compatible.

At step 508, the IT products may be mapped to the IT categories and management structure. In mapping the IT products, a table with the IT categories and management may be created and each of the IT products may be listed in rows with the IT categories that are determined by owners listed in the management structure to best describe the IT products. At step 510, a disposition status from among multiple potential disposition statuses is assigned to each of the IT products. The potential disposition statuses may include “kill,” “cap,” and “grow,” as described above. After disposition statuses have been created, the organization is to embark on executing the dispositions to eliminate the IT products that have been given a disposition status of “kill,” and focus on use of the IT products that have been given a disposition status of “grow.” To assist members of the entire organization follow the plan, a “standards” chart that lists each of the IT products with the “grow” status may be generated and given to each of the purchasers of IT so that future IT products are limited to be those “grow” IT products or other IT products (e.g., business applications) that ate compatible with the “grow” IT products. The IT products described herein are generally IT infrastructure products, but IT products that are business applications may be classified in the same or analogous manner.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for managing information technology (IT) products within an organization, said method comprising:
defining categories of IT products being utilized by an organization;
assigning a management structure to each IT product category, the management structure identifying at least one individual having responsibility for each respective IT product category;
creating an inventory list of IT products being used by the organization;
mapping the IT products to the IT product categories and management structure;
assigning a disposition status from among a plurality of potential disposition statuses to each of the IT products; and
dispose of the IT products as assigned by each respective disposition status.

2. The method according to claim 1, wherein defining categories of IT products includes defining domains and sub-domains in which IT products are to be mapped.

3. The method according to claim 2, wherein assigning a management structure to each IT product category includes assigning multiple individuals having different levels of responsibility for each domain and sub-domain.

4. The method according to claim 1, wherein assigning a disposition status includes assigning one of “kill,” “cap,” or “grow” to terminate, maintain as-is, or support, respectively, the IT products.

5. The method according to claim 4, further comprising creating a standards list of IT products that are assigned a disposition status of “grow.”

6. The method according to claim 5, further comprising limiting purchasing new IT products that are not supported by the IT products on the standards list.

7. The method according to claim 4, further comprising changing the disposition status to “retired” in response to an IT product being terminated.

8. The method according to claim 1, further comprising conducting an interlock meeting with the individuals assigned to the IT product categories to determine which disposition status to assign to the IT product categories.

9. The method according to claim 1, further comprising appointing a manager to manage the individuals assigned to disposition of the IT products.

10. The method according to claim 1, further comprising generating a disposition count for the IT product categories.

11. The method according to claim 1, further comprising:
cleansing the inventory list of IT products to eliminate duplicates and redundancies; and
generating a cleansed inventory list.
